(19) United States
(12) Patent Application Publication
(10) Pub. No.: US 2008/0042727 A1
(43) Pub. Date: Feb. 21, 2008

(54) Device for limiting the capacitance charging current, charge pump arrangement, method for limiting a charging current at a charge pump and method for limiting the charging current at a capacitor

(76) Inventors: Marco Goetz, Radebeul (DE); Rico Srowik, Dresden (DE)

Correspondence Address: SLATER & MATSIL LLP, 17950 PRESTON ROAD, SUITE 1000, DALLAS, TX, 75252, US

(21) Appl. No.: 11/584,809

(22) Filed: Oct. 19, 2006

(30) Foreign Application Priority Data
Aug. 4, 2006 (DE) 10 2006 036 546.1

(51) Int. Cl. G05F 1/10

(52) U.S. Cl. 327/536

(57) ABSTRACT

A device limits a capacitance charging current. The device has a differentiating device that is coupled in parallel with a capacitance that is to be charged at a charging node. A switching device is connected to an output of the differentiating device. The switching device prevents a charging current—which is supplied to the capacitor—if a predetermined value is applied to the output of the differentiating device.

This application claims priority to German Patent Application 10 2006 036 546.1, which was filed Aug. 4, 2006 and is incorporated herein by reference.

### TECHNICAL FIELD

Embodiments of the invention relate to a device for limiting the capacitance charging current, to a method for limiting the charging current at a capacitor and to a method for limiting a charging current.

### BACKGROUND

In microelectronics, it has always been a problem to provide a sufficient peak energy value. This problem has intensified further with increasing miniaturization since smaller components can also carry only a smaller current. In order to illustrate this problem, the following example shall be explained. Flash memory cells are programmed by storing charge in the memory zone or memory gate of a flash cell. A particular voltage that is generally provided using charge pumps is required for storage. Since a multiplicity of flash cells are generally simultaneously programmed, the charge pump must provide not only a sufficient voltage value but also, at the same time, a sufficient current. This means that the charge pump simultaneously requires a sufficiently high input current.

Flash memory cells are used, for example, in memory cards that are used in external devices, for example cameras, audio players, etc. Since the memory cards do not have their own energy source, the external devices must provide the power supply. This consequently means that the charging current that must be provided for the charge pump during the storage operation of the flash memory cells must also be provided by the external device. The maximum available charging current is not arbitrary but rather is prescribed by the external devices. If this maximum value is exceeded, it may result in operational faults in the external device. Such an operational fault could mean, for example, that the camera in which such a memory card has been used is reset when the maximum charging current provided by the camera is exceeded. On the one hand, this not only means that, in the event of such a reset, the user can continue to use his camera after a delay but also that the storage operation as such was interrupted and image information has possibly been lost.

However, flash memory cells are used not only in such memory cards but also as circuit parts in various other circuits and it is easily understandable that it is always at least undesirable for operation of such a circuit to be disrupted during a storage operation. However, charge pumps are also used in a variety of ways. It is always undesirable for the input current to exceed a prescribed maximum value.

The invention is consequently based on the fundamental problem of limiting capacitive charging currents using simple means.

### SUMMARY OF THE INVENTION

According to embodiments of the invention, this is effected by providing a device for limiting the capacitance charging current. The device includes a differentiating device that is connected in parallel with a capacitance that is to be charged at a charging node. Provision is made for a switching device that is connected to an output of the differentiating device. The switching device prevents a charging current, which is supplied to the capacitor, if a predetermined value is applied to the output of the differentiating device.

Embodiments of the invention also provide a charge pump arrangement that includes a charge pump circuit, which converts an input voltage that is applied to a first input connection into an output voltage that is applied to an output connection. A control circuit is connected to the charge pump circuit in such a manner that an output current that is flowing at the output connection is determined and the charge pump circuit is deactivated if a predetermined maximum value is exceeded.

Embodiments of the invention also provide a method for limiting a current of a charge pump at a capacitor, in which a change in the voltage across the capacitor is monitored and the charging current through the charge pump is changed if a predetermined voltage change is exceeded.

Finally, provision is made for a method for limiting the charging current at a capacitor, in which the voltage change is detected and supplied to a differentiating device and the charging current is interrupted on the basis of the voltage change that has been differentiated.

### BRIEF DESCRIPTION OF THE DRAWINGS

The invention is specifically explained in more detail below with reference to the drawings.

FIG. 1 shows a schematic illustration of an exemplary embodiment of a current limiting circuit; and

FIG. 2 shows a more detailed refinement of the current limiting circuit illustrated in FIG. 1.

### DETAILED DESCRIPTION OF ILLUSTRATIVE EMBODIMENTS

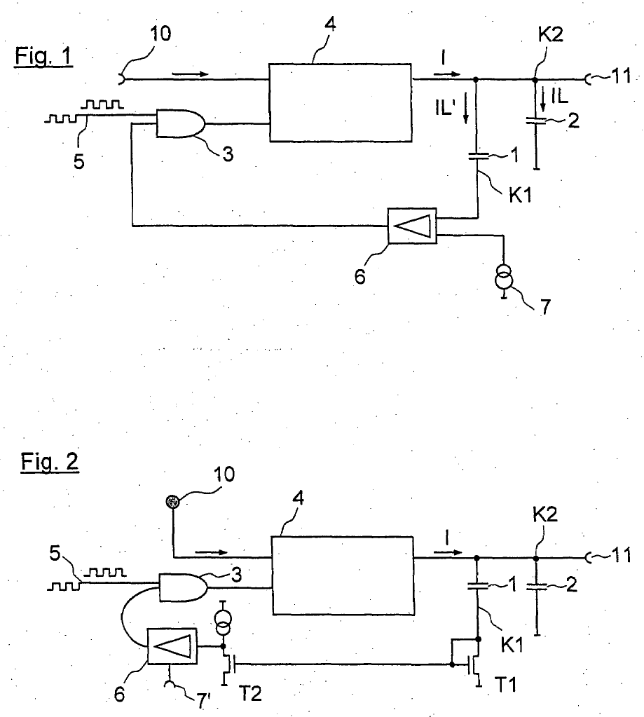

As shown in FIG. 1, provision is made for a charge pump circuit 4 that can be connected to a connection 10 of an input voltage and that can be used to supply an input current. This charge pump circuit 4 is connected, via the output 11, to a circuit for which it is intended but is not illustrated. In this case, the capacitor 2 depicts the capacitive load of the circuit that can be connected to the output 11. Via an AND circuit 3 a clock signal is supplied from the connection 5 to the charge pump circuit 4. The clock signal supplied clocks the charge pump circuit and correspondingly converts the input voltage that is applied to the input 10 into an output voltage. However, this output voltage is immediately present at the output only when there is no load. When there is a capacitive load, the output voltage rises in accordance with an E-function on the basis of the capacitive load, that is to say on the size of the capacitor 2. The larger the capacitive load, the larger the load current IL, as is symbolically indicated at the capacitor 2 in FIG. 1. The magnitude of the load current IL allows the voltage across the capacitor 2, which is connected between ground and the load current node K2, to rise. A capacitor 1 is likewise connected to the load current node K2.

The current that flows into the capacitor 1 is proportional to the voltage rise at the load current node K2. The difference between the load current in the capacitor 2 and the load current IL′ in the capacitor 1 corresponds to the difference between the capacitor 2 and the capacitor 1. As shown in FIG. 1, provision is made of a comparison circuit 6 that compares the current IL′ for the capacitor 1, which current is supplied to the comparison circuit 6 via the connection K1, with a reference current from a reference current source 7.

The output signal from the comparison circuit 6 is digital. The coding is such that, when the load current IL′ is higher than the reference current, the logic circuit part 3 is used to prevent the clock signal that is supplied via the connection 5. In situations in which the current IL′ is lower than the reference current from the reference current source 7, the coded signal from the comparison circuit 6 is such that the clock signal, which is supplied via the connection 5, is supplied to the charge pump circuit 4 via the logic circuit device 3.

Some explanations regarding the circuit shown in FIG. 1 are given below. In principle, the output current from the charge pump circuit 4 is composed of the current IL′ and the load current IL. If the capacitor 1 is sufficiently small in comparison with the capacitor 2, the output current I from the charge pump circuit 4 corresponds to the load current IL in the capacitor 2. The output current I from the charge pump circuit 4 is proportional to the input current flowing via the input connection 10 that means a multiple of the input current. If the input current is now intended to be limited, only the output current I that is proportional thereto needs to be limited. This means that, when the capacitor 1 is sufficiently small in comparison with the capacitor 2, the current IL must be limited. As already indicated above, the current IL is proportional to the voltage rise at the load current node K2. This voltage rise in turn gives rise to a proportional current IL′ that is again compared with the reference current. This always means that the maximum input current can be selected with the choice of reference current from the reference current source 7.

FIG. 2 shows a further refinement of the circuit arrangement shown in FIG. 1; in this case, identical parts are provided with identical reference symbols. The current through the capacitor 1 is converted, at the transistor T1, into a voltage that is in turn supplied to the gate connection of a transistor T2. The transistor T2 is connected between a current source and a ground connection. The voltage drop that is applied to the gate connection is correspondingly dropped across the output connection of the transistor T2, which is connected to the comparison circuit 6, since the current passed through the transistor T2 is proportional to the voltage that is present at the gate connection. The comparison circuit 6 compares the voltage that is supplied from the output connection of the transistor T2 with a voltage (not illustrated) that is applied to the comparison input 7′. The comparison result is supplied to the logic circuit device 3, which may be in the form of an AND circuit, for example. In accordance with the signal from the comparison circuit 6, the AND circuit 3 supplies the clock signal, which is supplied to the connection 5, to the charge pump circuit 4 or prevents the clock signal, which in turn limits the input current that is supplied to the charge pump circuit 4 via the connection 10.

What is claimed is:

1. A device for limiting the capacitance charging current, said device comprising:
a differentiating device coupled in parallel with a capacitance that is to be charged at a charging node; and
a switching device coupled to an output of the differentiating device, the switching device preventing a charging current that is supplied to a capacitor if a predetermined value is applied to the output of the differentiating device.

2. The device for limiting the capacitance charging current as claimed in claim 1, wherein the differentiating device includes a capacitor.

3. The device for limiting the capacitance charging current as claimed in claim 1, wherein the charging current for the capacitor is supplied by a charge pump circuit.

4. The device for limiting the capacitance charging current as claimed in claim 3, wherein the switching device controls operation of the charge pump circuit.

5. The device for limiting the capacitance charging current as claimed in claim 4, wherein the switching device is designed in such a manner that it prevents a clock signal for the charge pump circuit if the output of the differentiating device signals an excessively high charging current at the capacitor.

6. The device for limiting the capacitance charging current as claimed in claim 5, wherein the charging current at the capacitor is determined in the form of a change in a voltage across the charging node of the differentiating device.

7. A charge pump arrangement comprising:
a charge pump circuit that converts an input voltage that is applied to a first input connection into an output voltage that is applied to an output connection; and
a control circuit coupled to the charge pump circuit in such a manner that the control circuit determines an output current that is flowing at the output connection and deactivates the charge pump circuit if a predetermined maximum value is exceeded.

8. The charge pump arrangement as claimed in claim 7, wherein the control circuit includes a differentiating device that determines the output current in the form of a voltage change at the output connection.

9. The charge pump arrangement as claimed in claim 7, wherein a clock signal at a second input connection is supplied to the charge pump circuit, the clock signal being prevented if the predetermined maximum output current is exceeded.

10. The charge pump arrangement as claimed in claim 9, wherein the clock signal is supplied to the charge pump circuit via a logic circuit.

11. The charge pump arrangement as claimed in claim 10, wherein the logic circuit comprises an AND circuit.

12. A method for limiting a charging current of a charge pump at a capacitor, the method comprising:
monitoring a change in voltage across the capacitor; and
changing the charging current through the charge pump if the change in voltage across the capacitor exceeds a predetermined voltage change.

13. The method as claimed in claim 12, wherein changing the charging current through the charge pump comprises deactivating the charge pump.

14. The method as claimed in claim 13, wherein the change in the voltage is converted into a current and this current is compared with a reference current.

15. A method for limiting charging current at a capacitor, the method comprising:
detecting a voltage change;
supplying an indication of the voltage change to a differentiating device; and
interrupting the charging current on the basis of the voltage change that has been supplied to the differentiating device.

16. The method as claimed in claim 15, wherein the voltage change across the capacitor is converted into a current value by means of a difference, the current value is compared with a reference current by a comparison device and a comparison result is used as a control signal for interrupting the charging current.

17. The method as claimed in claim 15, wherein the charging current is interrupted by virtue of the fact that the charging current comes from a controlled current source and a control signal for the current source is interrupted.

18. The method as claimed in claim 17, wherein the voltage change across the capacitor is converted into a current value by means of a difference, the current value is compared with a reference current by a comparison device and a comparison result is used as a control signal for interrupting the charging current.
